(19) United States
(12) Patent Application Publication
(10) Pub. No.: US 2009/0299735 A1
(43) Pub. Date: Dec. 3, 2009

(54) Method for Transferring an Audio Stream Between a Plurality of Terminals

(76) Inventors: Bertrand Bouvet, Perros-Guirec (FR); Aurélien Sollaud, Trebeurden (FR); Jean-Marc Pageot, Trelevern (FR)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/442,353

(22) PCT Filed: Sep. 18, 2007
(86) PCT No.: PCT/FR2007/051963

§ 371 Date: Mar. 20, 2009

(30) Foreign Application Priority Data
Sep. 20, 2006 (FR) 06 53844

(51) Int. Cl. G10L 19/00

(52) U.S. Cl. 704/201; 704/E19.001

(57) ABSTRACT

A method of transferring an audio stream between at least two terminals, comprising the following steps: a step of connecting a first device and at least a second device; and a step of transferring an audio stream from the first device to the second device; the method being characterized in that it further comprises the following steps: a determination step during which it is determined that the first device or a first network to which the first device is connected or a second network to which the second device is connected is adapted to produce or transfer an audio stream comprising N channels and that the second device includes an electroacoustic transducer adapted to receive an audio stream comprising P channels; and a conversion step during which an audio stream sent by the first device or transmitted by the first network or transmitted by the second network is converted into an audio stream comprising P channels. An associated transfer system is also disclosed. Application to telephone or videophone communication in IP networks.

In the field of telecommunications, the invention relates to a method of transferring an audio stream between at least two terminals.

For example, the invention finds an application in the field of telephone or videophone communication in point-to-point mode between two devices or in conference mode involving more than two devices, including terminals, messaging voice servers, Audiotel devices, portals, etc.

The invention is of particular benefit in the context of telephone or videophone communication between:

firstly, at least one device connected to a new generation VoIP network (Voice over IP, Voice over IP network, IP telephone or Internet telephone) enabling transport of multichannel voice streams, for example stereophonic streams; and

secondly, at least one device connected to a traditional telephone network enabling only transport of monophonic voice streams (only one channel) for example a public switched telephone network (PSTN), an integrated services digital network (ISDN), a private business telephone network connected to the public network via a PABX (Private Automatic Branch exchange), a GSM mobile network or a conventional monophonic Voice over IP service.

More generally, the invention finds an application in any form of communication between at least two devices at least one of which has capacities for processing audio streams comprising a greater number of channels than an audio stream that can be processed by the other device(s).

Here the expression audio capacity (or audio property) means the capacity of a device or network to produce, transmit, receive and/or process a multichannel audio stream comprising N channels where N is an integer number greater than or equal to 1.

At present the telephone service still relies to a very great extent on fixed or mobile circuit-switched communications networks adapted to manage monophonic audio streams, as in monophonic telephone communication.

Telephone and videophone networks and services are expanding, and can be used with PC (Personal Computer) terminals provided with VoIP telephone or videophone software or with telephone terminals provided with means for stereophonic reproduction of an audio stream (for example a stereophonic loudspeaker or headphone system).

However, in practice, the stereophonic properties of some terminals can be used only if the terminals are in communication with at least one other device (terminal or server) having stereophonic properties. At present, most telephone calls use at least one device (terminal or server) that does not have stereophonic properties and for this reason telephone call audio streams are monophonic.

The invention offers a technical solution that is free of these drawbacks.

To this end, the invention proposes a method of transferring an audio stream between at least two devices, comprising the following steps:

a step of connecting a first device and at least a second device; and

a step of transferring an audio stream from the first device to the second device;

the method being characterized in that it further comprises the following steps:

a determination step during which it is determined that the first device or a first network to which the first device is connected or a second network to which the second device is connected is adapted to produce or transfer an audio stream comprising N channels and that the second device includes an electroacoustic transducer adapted to receive an audio stream comprising P channels; and

a conversion step during which an audio stream sent by the first device or transmitted by the first network or transmitted by the second network is converted into an audio stream comprising P channels.

Thus the method of the invention enables the user of a device provided with means for processing audio streams comprising P channels to benefit from the properties of their device, even if the other party is using a device or a network with different and possibly inferior audio properties.

The determination step can advantageously be effected during the connection step. Information usually exchanged between the devices during the connection step can therefore be used simultaneously during the determination step.

More generally, the determination step can be effected at any time during a call, possibly after a step of transferring an audio stream. For example, this enables a user of the second device who realizes that an audio stream that the second device is receiving comprises a number N of channels less than the audio processing capacities P of the processing means of the second device.

In one particular embodiment of the invention, the conversion step is effected only if N is less than P, i.e. only if the first device and/or the first network and/or the second network has/have audio capacities inferior to the audio capacities of the second device. This avoids effecting a conversion step if its effect (increasing the number of channels of the audio stream) is of no benefit for the second terminal.

The conversion step can be effected during the transfer step. This makes the transfer step totally transparent for the second device.

The conversion step can further comprise surround sound processing of the monophonic stream. This technique imparts a surround sound effect to an audio stream.

Also, a binaural filter can be used during the transfer step. Such filters impart a stereophonic effect to a monophonic audio stream.

The determination step and/or the conversion step can be software tasks adapted to be carried out in:

an audio output peripheral of the second device, including a stereophonic electroacoustic transducer, for example a peripheral including at least two loudspeakers; or

the second device; or

an equipment enabling the second device to access the second network; or

an input unit of the second unit; or

a voice resource server of the second communications network; or

an application server of the second network dedicated to implementing the method.

The determination step can be a software task that can be executed in a call processing server of the second communications network and the conversion step is effected by a media server of said second communications network each time a monophonic audio stream is received that was sent by the first device and/or transmitted by the first network.

The invention also relates to a communications system comprising:

means for connecting a first device and at least a second device; and

means for transferring an audio stream from the first device to the second device;

the system being characterized in that it further comprises:

determination means adapted to determine that the first device or a first network to which the first device is connected or a second network to which the second device is connected is adapted to produce or transfer an audio stream comprising N channels and that the second device includes an electroacoustic transducer adapted to receive an audio stream comprising P channels; and

conversion means by which an audio stream sent by the first device or transmitted by the first network or transmitted by the second network is converted into an audio stream comprising P channels.

The invention can be better understood and other features and advantages become apparent on reading the following description of embodiments of a connection method and a connection system of the invention.

The description is given with reference to the appended drawings, in which:

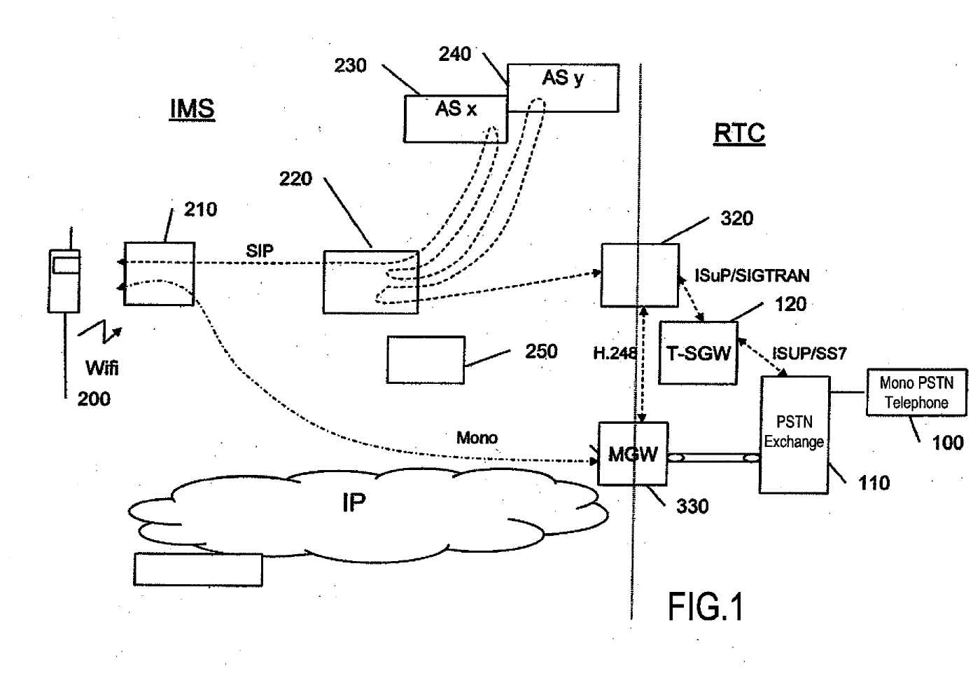

FIG. 1 is a block diagram showing the use of a prior art method of transferring an audio stream between two terminals engaged in a call; and

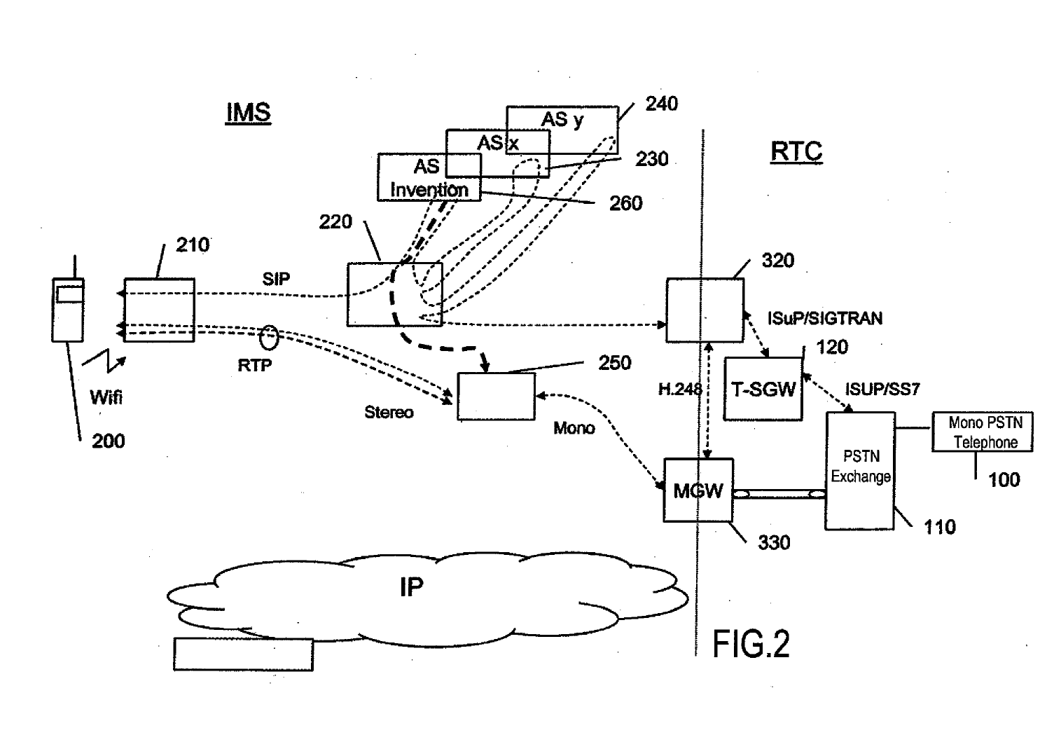

FIG. 2 is a block diagram showing the use of a method of the invention for transferring an audio stream between two terminals engaged in a call.

The method of the invention is described firstly below in the context of a call between first and second devices taking the form of particular first and second terminals.

In other embodiments of the invention, there could be more than two devices and the devices could include servers, for example Audiotel information servers or voicemail servers, etc.

Here the first terminal is connected to a public switched telephone network (PSTN) that is not adapted to transfer stereophonic audio streams. In a concrete example the first terminal is a standard fixed telephone 100 of which at least a base unit is connected by a cable to a PSTN telephone jack.

Here the second terminal is connected to a Voice over IP telephone network and has a stereophonic electroacoustic transducer and two audio input ports adapted to receive a stereophonic audio stream transmitted on two audio channels of the Voice over IP network. The second terminal is a mobile telephone 200, for example, connected by a WiFi link to a unit 210 connected to the second network and including by way of an electroacoustic transducer stereophonic headphones with two earpieces.

FIG. 1 shows diagrammatically the conventional routing of an audio signal between the user of the first terminal 100 and the user of the second terminal 200 during a telephone call.

In this example, the first network is the PSTN using an ISUP (Integrated Services Digital Network Signaling User Part) signaling protocol. It includes an exchange 110, which is the point of connection of the first terminal to the PSTN, and an input unit 120 for managing call requests (T-SGW), the main function of which is to act as a gateway for transporting ISUP call request signaling in different protocol layers, and also having the function of forwarding a call request sent by or for the first terminal.

The second network is a Voice over IP network with an INS (IP Multimedia Subsystem) architecture using an SIP (Session Initiation Protocol) signaling protocol. It includes an input unit 220 (P-I-S-CSCF) the main functions of which are identifying and registering the terminal 200 on the second network and forwarding a call request sent by or on behalf of the terminal 200.

The second network can also include one or more servers 230, 240 able to provide the user of the second terminal with one or more application-based services such as a voicemail service, for example, or an additional telephone service, such as call waiting management. The second network can also include a voice resource server 250, for example having the function of sending an audio stream containing a voice message, performing voice recognition on an audio stream or mixing received audio streams in the context of a conference call.

The two networks are interconnected by a connection gateway 320 and a data gateway 330.

A method of communication between the user of the first terminal and the user of the second terminal includes two main steps, a connection step and a step of audio stream transfer from one terminal to the other.

The connection step is effected in the following manner. The second terminal sends an SIP call request that is forwarded by the unit 210 and then by the input unit 220 to the gateway 320, which converts the request to the ISUP format and forwards it to the input unit 120, which finally forwards it to the first terminal via the exchange 110. If the user of the first terminal accepts the call (by activating the telephone handset of the first terminal), an acceptance of the connection is sent to the second terminal by a reverse path via the unit 110, the unit 120, the gateway 320, the unit 220 and then the unit 210. Of course, if the call is at the initiative of the user of the first terminal, the call request is sent by the first terminal to the second terminal and the acceptance of the call follows the reverse path.

After reception by the second terminal of the call acceptance, a communications channel is set up between the second terminal, the connection unit 210, the data gateway 330, the exchange 110, and the first terminal, and audio signals are transferred between the users by means of the audio stream on the communications channel between the two terminals. The transfer step can be repeated several times during the call. In a PSTN and in an IP telephone network the audio streams are monophonic and are transmitted on a single channel.

A communication method of the invention differs from a prior art method in that it also includes the following steps:

a determination step during which it is determined that the first device or a first network to which the first device is connected or a second network to which the second device is connected is adapted to produce or transfer an audio stream comprising N channels and that the second device includes an electroacoustic transducer adapted to receive an audio stream comprising P channels; and

a conversion step during which an audio stream sent by the first device or transmitted by the first network or transmitted by the second network is converted into an audio stream comprising P channels.

In the chosen example:

the determination step is effected during the connection step; and

the conversion step is effected during the transfer step and only if P is greater than N.

In the chosen example, the first terminal, which is a standard fixed telephone, comprises no means for producing a stereophonic audio stream. The first network to which the first terminal is connected is the PSTN, which is adapted to transfer monophonic audio streams but has no means for transferring stereophonic audio streams. N is thus equal to 1, corresponding to a monophonic stream. The second terminal includes a stereophonic electroacoustic transducer, and is therefore adapted to receive an audio stream comprising P=2 channels.

The determination step therefore leads to a positive conclusion.

The conversion step is executed thereafter each time an audio stream is transferred from the first terminal to the second terminal.

FIG. 2 shows an embodiment of the method of the invention using an application server 260.

In this embodiment, the determination step is effected by determination means in the application server 260 and the conversion step is effected by conversion means in the voice resource server 250 of the second network and controlled by the application server 260.

In the chosen example, the determination step is effected during the step of connecting the two terminals, in the following manner:

when the input unit 220 receives a call request, it forwards it to the determination means of the server 260 which, on the basis of parameters of said call request, determine the audio properties (the number of channels to be processed in parallel for the same sound) of the terminal that sent the call request and the network to which said terminal is connected; in the chosen example, P=2 for the second terminal, after which:

when the input unit 220 receives the call acceptance, it forwards it to the determination means of the server 260 which, on the basis of parameters of said call acceptance, determined the audio properties of the terminal that sent the call acceptance; in the chosen example, N=1 for the first terminal, after which:

the determination means of the server 260 decide whether the conversion step should be effected or not.

If the conversion step should be effected, the determination means of the server 260 command the conversion means of the voice resource server 260 accordingly.

If the conversion step should not be effected, because the audio properties of the second terminal are the same as or inferior to the audio properties of the first terminal, the first network and/or the second network, then the transfer step is effected as in the prior art methods, without passing through the voice resource server 250.

In the chosen example, the conversion step is effected by the conversion means of the voice resource server 250 each time an audio stream is transferred from the first terminal to the second terminal:

the monophonic stream sent by the first terminal 100 is forwarded to the conversion means of the server 250 via the exchange 110 and the data gateway 330;

the conversion means convert the monophonic stream into a stereophonic stream; and

the conversion means forward the stereophonic stream to the second terminal 200 via a single communications channel comprising two audio channels.

Conversion of the monophonic stream includes surround sound processing of the monophonic stream, for example using a binaural filter.

Surround sound processing of a monophonic audio signal aims to give a listener the illusion that the sound source or sources are at precise locations in a space having particular acoustic properties (reverberation, masking, etc.). Binaural synthesis is one particular technique for positioning sound sources providing a surround sound effect. Details of this technique can be found in the patent FR 2 851 879 or in the book by Blauert, J., “Spatial hearing—the psychoacoustics of human sound localization”, MIT Press, Cambridge, Mass., (1983).

In the FIG. 2 embodiment of the invention, the stream is converted by conversion means in the voice resource server 250 of the second network to which the terminal having stereophonic acoustic means is connected.

Many other embodiments of the invention can be envisaged.

In another embodiment, conversion is effected by conversion means in the application server 260. The application server then performs all the steps of the method specific to the invention, in particular the determination step and the conversion step.

In another embodiment, the determination step and the conversion step can be effected at the end of the transfer step, beyond the second network:

by determination means and conversion means in the connection unit 210 connecting the second device to the second network; or

by determination means and conversion means in the second device; or

by determination means and conversion means in the acoustic output peripheral of the second device.

It should be remembered that the first device and/or the second device can be terminals or servers.

For example, the determination means and the conversion means can be software tasks carried out, according to the embodiment concerned:

in the connection equipment 210 connecting the second terminal to the second network; or

in the second terminal; or

in the acoustic output peripheral of the second terminal; or

in the resources server 250 of the second network; or

in the application server 260.

It should be remembered that the first network and the second network can be one and the same Voice over IP network able to transfer stereophonic streams. In this situation the invention is of benefit if the first terminal has no means for producing a stereophonic audio stream and the conversion means can be anywhere along the channel for transferring an audio stream between the first and second terminals.

The first network and the second network can also be one and the same network unable to transfer stereophonic audio streams. In this situation the determination means and the conversion means can be in the second terminal or in the acoustic output peripheral of the second terminal.

The FIG. 2 example uses the ISUP as the communications protocol in the first network and the SIP as the communications protocol in the second network. Of course, any other communications protocol appropriate to the first and/or the second network can be employed.

The invention can also be implemented on a subscription basis, rather than systematically. In this situation the application server 260 can include means for managing subscribers.

The connection step is effected at the start of a call, with a view to setting up a call between the devices. In the chosen example, the determination step is effected in parallel with the connection step. However, the determination step can instead be carried out during a call, after a connection step and one or more transfer steps, for example at the request of the user of the second device (for example by pressing a control key) who wishes, during the call, to benefit from the audio properties of their device, of which they did not have the benefit at the start of the call. The properties of the call in progress are thus renegotiated, as it were.

Moreover, it should be remembered that the invention can be applied to any transfer of audio streams of any telephone or videophone call between two or more devices such as terminals or servers.

1. A method of transferring an audio stream between at least two devices, comprising the following steps:
a step of connecting a first device and at least a second device; and
a step of transferring an audio stream from the first device to the second device;
a determination step during which it is determined that the first device or a first network to which the first device is connected or a second network to which the second device is connected is adapted to produce or transfer an audio stream comprising N channels and that the second device includes an electroacoustic transducer adapted to receive an audio stream comprising P channels; and
a conversion step during which an audio stream sent by the first device or transmitted by the first network or transmitted by the second network is converted into an audio stream comprising P channels.

2. A method according to claim 1, wherein the determination step is effected during the connection step.

3. A method according to claim 1, wherein the conversion step is effected only if N is less than P.

4. A method according to claim 1, wherein the conversion step is effected during the transfer step.

5. A method according to claim 1, wherein the conversion step includes surround sound processing of the audio stream.

6. A method according to claim 1, wherein a binaural filter is used during the conversion step.

7. A method according to claim 1, wherein the determination step and/or the conversion step are software tasks adapted to be carried out in:
an audio output peripheral of the second device, including a stereophonic electroacoustic transducer, for example a peripheral including at least two loudspeakers; or
the second device; or
an equipment enabling the second device to access the second network; or
an input unit of the second unit; or
a voice resource server of the second network; or
an application server of the second network dedicated to implementing the method.

8. A method according to claim 1, wherein the determination step is a software task that can be executed in a call processing server of the second communications network and the conversion step is effected by a media server of said second communications network each time a monophonic audio stream is received that was sent by the first device and/or transmitted by the first network.

9. A communications system comprising:
means for connecting a first device and at least a second device; and
means for transferring an audio stream from the first device to the second device;
determination means adapted to determine that the first device or a first network to which the first device is connected or a second network to which the second device is connected is adapted to produce or transfer an audio stream comprising N channels and that the second device includes an electroacoustic transducer adapted to receive an audio stream comprising P channels; and
conversion means by which an audio stream sent by the first device or transmitted by the first network or transmitted by the second network is converted into an audio stream comprising P channels.

10. A system according to claim 9, wherein the determination means are in an application server.

11. A system according to claim 9, wherein the conversion means are in an application server or in a voice resource server.
